(19) United States
(12) Patent Application Publication
(10) Pub. No.: US 2002/0170733 A1
(43) Pub. Date: Nov. 21, 2002

(54) Method of producing a superconducting cable

(75) Inventor: Claus Nygaard Rasmussen, Vanlose (DK)

Correspondence Address: LADAS & PARRY, 26 WEST 61ST STREET, NEW YORK, NY, 10023, US

(73) Assignee: NKT CABLES A/S

(21) Appl. No.: 10/135,178

(22) Filed: Apr. 29, 2002

Related U.S. Application Data
(63) Continuation of application No. PCT/DK00/00597, filed on Oct. 27, 2000.

(30) Foreign Application Priority Data
Oct. 29, 1999 (DK) PA199901545

(51) Int. Cl. H01B 1/00; H02G 1/00

(52) U.S. Cl. 174/68.1

(57) ABSTRACT

U 013971-0 A method of producing a superconducting cable, where a plurality of superconducting ribbons (4) are applied onto a preferably flexible tube (3), said ribbons being applied in one or more layers, optionally separated by intermediate plastic layers, whereafter a protective layer (5) of textile or paper is optionally applied followed by a metal tube (6). A plurality of film layers are applied onto the metal tube (6), a few of said layers being metal-coated. Subsequently, a number of preferably helical spacers (12) are applied onto there layers, and finally a screen (9) is placed on said spacers (12). In this manner the vacuum between the tubes (6 and 9) minimize the thermal conductivity at the same time as the metal-coated films block the thermal radiation. Compared to a conventional cryostate, an increase of the influx of heat is met by increasing the number of film layers and by inserting a predeteremined number of aluminium-coated layers serving both as equipotential surfaces and as equitemperature surfaces.

### TECHNICAL FIELD

The invention relates to a method of producing a superconducting cable, where a plurality of superconducting ribbons are applied onto a preferably flexible tube, said ribbons being applied in one or more layers, optionally separated by intermediate plastic layers, whereafter a protective layer of textile or paper is optionally applied followed by a metal tube serving as the innermost wall of a cryostate, and whereby a plurality of for instance helical spacers are applied onto said metal tube followed by a final outer metal tube serving as the outermost wall of the cryostate.

### BACKGROUND ART

Today two main types of superconducting cables are available, viz. cables with cryogenic, electric insulation and cables with electric insulation at room temperature.

The cables with cryogenic, electric insulation imply that the electric insulation is arranged directly on the outer side of the superconducting cable conductor with the result that they are cooled to the same temperature as the cable conductor. The electric insulation is preferably formed by many layers of plastic film impregnated with the coolant for the cable. The cryostate is provided on the outer side of the electric insulation, said cryostate erg a thermal separation between the surroundings and the cryogenic area. The cryostate comprises a multilayer insulation and vacuum. Each layer is formed by a plastic film coated with a tin reflecting layer of for instance aluminum. These layers are separated by a fine-meshed net of fibre glass. The vacuum minimizes the thermal conductivity at the same time as the film layers block the thermal radiation. However, such a cable takes up relatively much room.

The cables with electric insulation at room temperature imply that the electric insulation is arranged on the outer side of the cryostate. The electric insulation of the cable is more or less identical with the insulation of conventional cables and can for instance be formed by oil-impregnated paper or extruded plastics.

Furthermore, EP 0786783 A1 discloses a superconducting cable with cryostate insulation, said cryostate including a number of layers of insulating material coated with metal. All these layers are coated with metal. This involves a risk of electric short circuiting, especially at high electric voltages.

### BRIEF DESCRIPTION OF THE INVENTION

The object of the invention is to show how it is possible to combine the electric and the thermal insulation and thereby to obtain a superconducting cable taking up less room than hitherto known. Furthermore, the risk of electric short circuiting should be substantially eliminated.

A method of the above type is according to the invention characterised in that one or more electrically conducting or semi-conducting layers are arranged on the opposing inner walls of said cryostates, and that a number of film layers are inserted between the metal tubes and preferably below the spacers, said number of film layers comprising electrically insulating layers arranged in such a manner that a high electric potential difference can be applied between said metal tubes. A plurality of layers are inserted between the metal tubes and preferably below the spacers, at least a few of said layers being coated with a thin reflecting layer of metal. As a result the vacuum between the metal tubes minimizes the thermal conducitivity at the same time as the metal-coated films block the thermal radiation. It has turned out that it is sufficient that only few of said films are metal-coated. As a result, the risk of short circuiting is reduced, especially at high voltages.

Moreover, a network may according to the invention be inserted between the film layers.

The network may according to the invention be made of a semi-conducting or insulating material.

Furthermore the spacers may according to the invention be semi-conducting or insulating.

Finally, the spacers may according to the invention be of a varying shape.

### BRIEF DESCRIPTION OF THE DRAWING

The invention is explained in greater detail below with reference to the accompanying drawings, in which

FIG. 1 is a sectional view of a superconducting cable according to the invention, and

FIG. 2 is a perspective view of the cable of FIG. 1.

### BEST MODE FOR CARRYING OUT THE INVENTION

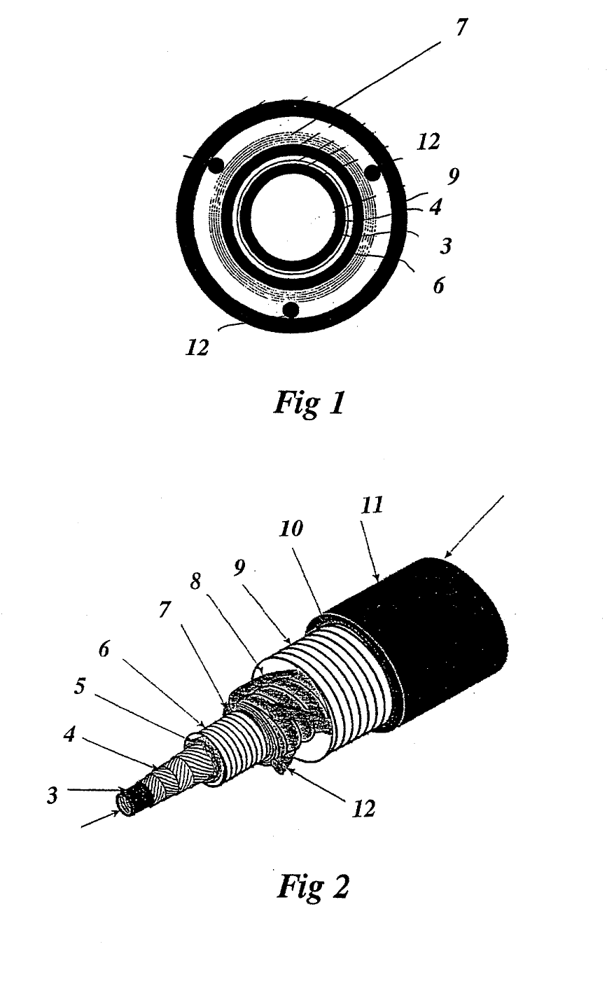

The superconducting cable illustrated in FIG. 1 comprises an inner, preferably flexible cooling tube 3 for the passage of liquid nitrogen. A superconducting ribbon 4 is wound onto this tube 3 according to a helical line in one or more layers, optionally separated by intermediate layers of plastics. The Figure shows four layers of super-conducting ribbon 4. However, nothing prevents more or less layers from being used. The winding direction of the superconducting ribbon 4 can for instance be altered from layer to layer. The layers of superconducting ribbon 4 are followed by a protective layer 5 of textile or paper and then by a metal tube 6 which serves as the inner wall of a cryostate. When this inner wall 6 has been completed, it is wound with one or more layers of semi-conducting layers of plastic film, viz. an inner semiconductor. This plastic film is to ensure an even surface and thereby an even electric field. The inner semiconductor is wound with a relatively large number of layers 7, said number depending on the voltage level etc. These layers 7 are alternately layers made of thin plastic film of for instance teflon, polypropylene or polyamide and layers made of fibre network which is either semi-conducting or electrically insulating and for instance made of fibre glass, carbon fibre or kevlar fibre. As the emittivity E of a pure plastic film is far higher (E plastics ≈0.8 to 0.9) than a bare aluminium surface (E aluminium ≈0.05), several layers of film are necessary. However, if only a few layers are strongly reflecting, then the amount of radiation added to the influx of heat is considerably reduced. Compared to a conventional cryostate, an increase of the influx of heat is met by increasing the number of film layers and by inserting a predetermined number of aluminium-coated layers, which also serve as equipotential surfaces and equitemperature surfaces. When the winding of these layers of insulation has been completed, yet another or more layers of semi-conducting plastic film are wound thereon, viz. the outer semiconductor. The winding on of the insulation by means of winding machines is carried out in the same manner as the winding of paper insulation onto conventional cable conductors.

The outer semiconductor is wound with spacers 12. These spacers 12 can optionally also be applied between one or more of the above layers of film. In most cases the latter must be semi-conducting and accordingly they provide an electric connection between the outer semiconductor and the outer cryostate wall 9 substantially without affecting the transmission of heat. The spacers 12 are of an either tubular or square cross section. In order to minimize the transmission of heat through the spacers 12, said spacers 12 can be of a varying diameter in such a manner that only at very few locations they fill out the space between the wound insulation and the outer vacuum tube 9. The spacers 12 can be of other shapes and be inserted sporadically before the application of the outer cryostate wall 9. Alternatively, these spacers 12 can be insulating.

The electric insulation can be provided in two ways.

The electric insulation can for instance be made of pure plastic film. The individual layers of film are separated by networks of fibre glass and optionally also by spacers. One or more layers of plastic film can be provided for each layer of network of fibre glass. This insulation constitutes between ⅔ and ¾ of the volume of the cryostate. The electric field propagates in response to the ratio of the dielectricity constants of the materials forming part of the insulation.

During ordinary operation the cryostate is evacuated, and accordingly a vacuum applies between the individual layers of film. The electric durability of vacuum is minimum 20 to 100 kV/mm in response to the length, across which the voltage applies. In case the cryostate leaks, atmospheric air can enter therein, but such a situation does not alter the electric field distribution because the dielectricity constant is the same for air and vacuum. However, the durability is a decade shorter for air than for vacuum, viz. 2 to 10 kV/mm in response to the length. When the electrically insulating cryostate is structured it must be ensured that the field strength nowhere exceeds the critical value although air should enter therein. The electric durability of thin plastic film is typically 20 to 100 kV/mm.

According to an alternative configuration, the distance between the aluminium-coated layers of film has been significantly reduced. The resulting total thickness of the insulation is reduced. However, no network is inserted between the layers of film, but only on both sides of the aluminium-coated layers. In the latter case, the network must be semi-conducting and can for instance be made of carbon fibre. As a result, the electric field in the layer of air between the films is displaced onto the plastic films which present a very high breakdown voltage. The remaining plastic layers are wound tightly so as thereby to limit the penetration of air between the layers in case air penetrates into the cryostate.

What is claimed is:

1. A method of producing a superconducting cable, where a plurality of superconducting ribbons (4) are applied onto a preferably flexible tube (3), said ribbons being applied in one or more layers optionally separated by intermediate plastic layers, whereafter a protective layer (5) of textile or paper is optionally applied followed by a metal tube (6) serving as the innermost wall of a cryostate, and whereby a plurality of for instance helical spacers (12) are applied onto said metal tube (6) followed by a final outer metal tube (9) serving as the outermost wall of the cryostate, the opposing walls of said metal tubes (6, 9) defining an inner volume of said cryostate, said inner volume being evacuated, wherein one or more electrically semi-conducting layers are arranged on the innermost wall (6) of said cryostate, and that a number of film layers are inserted between the metal tubes (6,9) and preferably below the spacers (12), said number of film layers comprising electrically insulating layers and a predetermined number of film layers coated with a thin reflecting layer of metal, serving as equipotential surfaces and equitemperature surfaces.

2. A method according to claim 1, wherein said electrically insulating layers are thin plastic films made from the group of materials comprising teflon, polypropylene, polyamide, and other plastic-based materials suitable for electrical insulation.

3. A method as claimed in claim 1, characterised in that the metal-coated films are wound according to a helical line with overlappings.

4. A method as claimed in claim 1, characterised in that a network of for instance fibre glass is inserted between the layers of film.

5. A method as claimed in claim 4, characterised in that each network is made of semi-conducting material.

6. A method as claimed in claim 4, characterised in that each network is made of insulating material.

7. A method as claimed in claim 1, characterised in that the spacers (12) are semi-conducting.

8. A method as claimed in claim 1, characterised in that the spacers (12) are insulating.

9. A method as claimed in claim 1, characterised in that the spacers (12) are of a varying shape.

10. A method according to claim 1, wherein at least one outer semiconducting layer is applied to said number of film layers.

11. A method according to claim 10, wherein said at least one outer semiconducting layer provides an electrical connection to the outer cryostate wall.

12. A method according to claim 1, wherein said spacers are applied between one or more of said number of film layers.

13. A method as claimed in claim 2, characterised in that the metal-coated films are wound according to a helical line with overlappings.

14. A method as claimed in claim 2, characterised in that a network of for instance fibre glass is inserted between the layers of film.

15. A method as claimed in claim 3, characterised in that a network of for instance fibre glass is inserted between the layers of film.

16. A method as claimed in claim 13, characterised in that a network of for instance fibre glass is inserted between the layers of film.

17. A method as claimed in claim 2, characterised in that the spacers (12) are semi-conducting.

18. A method as claimed in claim 3, characterised in that the spacers (12) are semi-conducting.

19. A method as claimed in claim 4, characterised in that the spacers (12) are semi-conducting.

20. A method as claimed in claim 5, characterised in that the spacers (12) are semi-conducting.
